(19) United States
(12) Patent Application Publication
(10) Pub. No.: US 2013/0099482 A1
(43) Pub. Date: Apr. 25, 2013

(54) COUPLING DEVICE AND CONNECTOR INCLUDING SUCH A DEVICE

(71) Applicant: STAUBLI FAVERGES, Faverges (FR)

(72) Inventors: Alain-Christophe TIBERGHIEN, SEVRIER (FR); Christophe DURIEUX, GILLY SUR ISERE (FR); Igor BAHNO, ALBERTVILLE (FR)

(73) Assignee: STAUBLI FAVERGES, Faverges (FR)

(21) Appl. No.: 13/658,969

(22) Filed: Oct. 24, 2012

(30) Foreign Application Priority Data
Oct. 25, 2011 (FR) 1159652

(51) Int. Cl. F16L 37/18

(52) U.S. Cl. CPC F16L 37/18
USPC 285/312

(57) ABSTRACT

A coupling device for transferring pressurized fluids including an end piece body having a bearing portion and defining a fluid flow channel, an end piece ring provided with an inner cavity and a threaded radial surface, and an element for displacing the end piece body in a forward direction parallel to a longitudinal axis of the end piece ring and inside the inner cavity. The device has an intermediate member having a body with a radial surface with an external thread complementary to the external thread of the end piece ring and a locking mechanism movable between a position blocking a coupling element introduced into the intermediate member and a position where the locking mechanism allows withdrawal of the coupling element from the intermediate member.

This invention relates to a coupling device. The invention also relates to a connector including such a device.

The field of the invention is that of connectors suitable for passage of high pressure and high temperature fluids demanding maximum safety and requiring metal part sealing. E.g., the pressure of the fluid is on the order of 200 bars, while the temperature is on the order of 300° C.

In particular, the coupling device according to the invention is provided to be coupled with tube-like elements going through a plate. In this case, the operations of installing and removing the tube through the plate must be fast and ergonomic.

GB-A-201 061 describes a coupling device between two tubes. A first tube is screwed into a main coupling element provided with a first frustoconical surface. The second tube is screwed into an end piece ring provided with a second frustoconical surface and whereon a tapped washer is installed. Sealing by truncated cone to truncated cone is obtained within the device by actuating a cam lever installed on the coupling element after the second tube has been inserted into the ring. Axial end play in the device, between washer and cam, must be compensated by acting upon the tapped washer, in a step prior to the actuation of the lever. Furthermore, if compensation of play is not perfect in spite of the actuation of the washer and lever, then sealing is not obtained. Also, as the device is wider than the tubes screwed thereto, removal of the coupling through a plate is not very convenient. Thus, the coupling device is lacking reliability and ergonomics.

GB-A-551 795 describes a connector adapted to be connected to a tube. In particular, the connector includes a casing, a deformable annular ring, an end piece body, and a lever. Actuating the lever will move the end piece body inside the casing so that the end piece body will flatten the deformable ring around the tube. Such a connector is not suitable for transferring high pressure and high temperature fluids.

The aim of the present invention is to propose a coupling device providing a reliable and ergonomic connection between two coupling elements, in particular, a male element going through a plate and a coupling end piece provided with a cam lever.

To that end, the invention relates to a coupling device, adapted to transfer pressurized fluids, said coupling device being connected to a first pipe and configured for coupling with a coupling element connected to a second pipe, with a first part among the coupling device and the coupling element that is configured as a male element, and a second part among the coupling device and the coupling element that is configured as a female element, the coupling device including:
an end piece body having a bearing portion and delimiting an internal flow channel of a fluid in the coupling device, with the end piece body being connected to the first pipe,
an end piece ring provided with an inner cavity which extends generally along a longitudinal axis and which is isolated from the internal flow channel for the fluid, and a radial surface having an external thread, and
displacement means for displacing the end piece body in at least one forward direction parallel to the longitudinal axis of the end piece ring, within the inner cavity of the end piece ring.
   Said coupling device also includes an intermediate member comprising:
a body which extends along a longitudinal axis and which is provided with a radial surface having an external thread complementary to the external thread of the end piece ring, and
a locking mechanism movable between, on the one hand, a blocking position for blocking the coupling element introduced into the intermediate member with respect to the intermediate member, in at least one forward direction parallel to the longitudinal axis of the body and, on the other hand, a position wherein the locking mechanism allows for the coupling element to be withdrawn from the intermediate member,
   the locking mechanism is able to be located in the blocking position thereof while the intermediate member is uncoupled from the end piece ring,
   and the bearing portion of the end piece body is capable of coming into sealing contact with the coupling element for sealingly coupling the first and second pipes.

Thus, the coupling device according to the invention has several advantages. By means of the locking mechanism, connection/disconnection between the intermediate member and the coupling element can be made easily and rapidly. In particular, such connection/disconnection can be made independently from the displacement of the end piece body by the means provided for this purpose. The connection between the external threads of the intermediate member and the end piece ring, which more precisely is a screw connection, compensates for play and tolerances: no adjustment prior to or during the connection is required, while constant tightening throughout connections/disconnections is guaranteed within the coupling device. Furthermore, the connection by means of a latch between the coupling element and the intermediate member allows for this intermediate member to freely rotate around the coupling element, and thus not to apply any torsional stress to the pipes of the coupling element and the end piece body during connection between the intermediate member and the end piece ring. Advantageously, the various connections are complementary to each other so as to secure the coupling element within the intermediate member. The means of displacement preferably include a cam lever reducing manual tightening and reinforcing sealing within the coupling, without any ancillary tools. Advantageously, the sealing contact within the device is established between two metal portions, without any elastomeric member having a shorter service life. Thus, the device according to the invention is particularly suitable for transferring high pressure and high temperature fluids between two sealingly coupled pipes.

According to other advantageous characteristics of the invention, taken separately or in combination:
The locking mechanism is capable of being housed at least partially inside a groove made in the coupling element.
The displacement means for displacing the end piece body include a lever and a pivoting cam in the end piece ring.
The lever is clevis-mounted around the end piece body, the cam being interposed along the longitudinal axis of the end piece ring between a shoulder of the end piece body and a shoulder of the end piece ring.
The cam has at least one outer surface, with a locking width and an unlocking width which is smaller than the locking width, with a difference between the locking width and the unlocking width being preferably on the order of 0.5% to 5%.
The displacement means also include a brake spring arranged between the end piece ring and the lever and capable of holding the lever in an angular locking and/or unlocking position.
The end piece ring includes an internal thread made at the inner cavity, while the intermediate member includes, on an external cylindrical surface of the body, an external thread complementary to the internal thread.
The locking mechanism includes a slide which is movable perpendicularly to the longitudinal axis of the body of the intermediate member and which has a housing traversed by the coupling element when it is introduced into the intermediate member, said housing being provided with a radial detachment for blocking the coupling element in the forward direction.
The slide includes a safety counterbore capable of receiving the coupling element in abutment in the forward direction, such safety counterbore covering an angular sector of at least 200° around a center axis of the safety counterbore.
The locking mechanism includes locking balls and a ring which is movable in parallel to the longitudinal axis of the body of the intermediate member around the body between, on the one hand, a position locking the balls in the coupling element so as to block the coupling element with respect to the intermediate member and, on the other hand, a position releasing the balls for withdrawal of the coupling element from the intermediate member.
The end piece ring includes an internal thread made at the inner cavity, while the intermediate member includes, on an external cylindrical surface of the body, an external thread complementary to the internal thread, and the ring at least partially covers the external thread of the intermediate member in the ball release position.
At least one bearing portion among the bearing portion of the coupling element and the bearing portion of the end piece body is a frustoconical surface.
The coupling device is configured as a female element suitable for receiving a male coupling element, with the bearing portion of the end piece body receiving in sealing contact a bearing portion of the male coupling element.

Also an object of the invention is a connector adapted to transfer pressurized fluids. This connector is characterized in that it includes a coupling device as mentioned above and connected to the first pipe, as well as a coupling element coupled with the coupling device and connected to the second pipe.

Advantageously, while the bearing portion of the end piece body is touching a bearing portion belonging to the coupling element, the displacement of the end piece body with respect to the coupling element in the forward direction via the displacement means is capable of establishing the sealing contact between the bearing portion of the end piece body and the bearing portion belonging to the coupling element for sealingly coupling the first and second pipes.

According to a first connector variant, the sealing contact between the bearing portion of the end piece body and the bearing portion of the male coupling element is established by direct contact of the two surfaces forming the bearing portions.

According to a second connector variant, one of both surfaces forming the bearing portions receives a gasket and the sealing contact between the bearing portion of the end piece body and the bearing portion of the male coupling element is made via the gasket.

The invention will be better understood upon reading the following description, provided only as a non-restrictive example and made with reference to the appended drawings, in which:

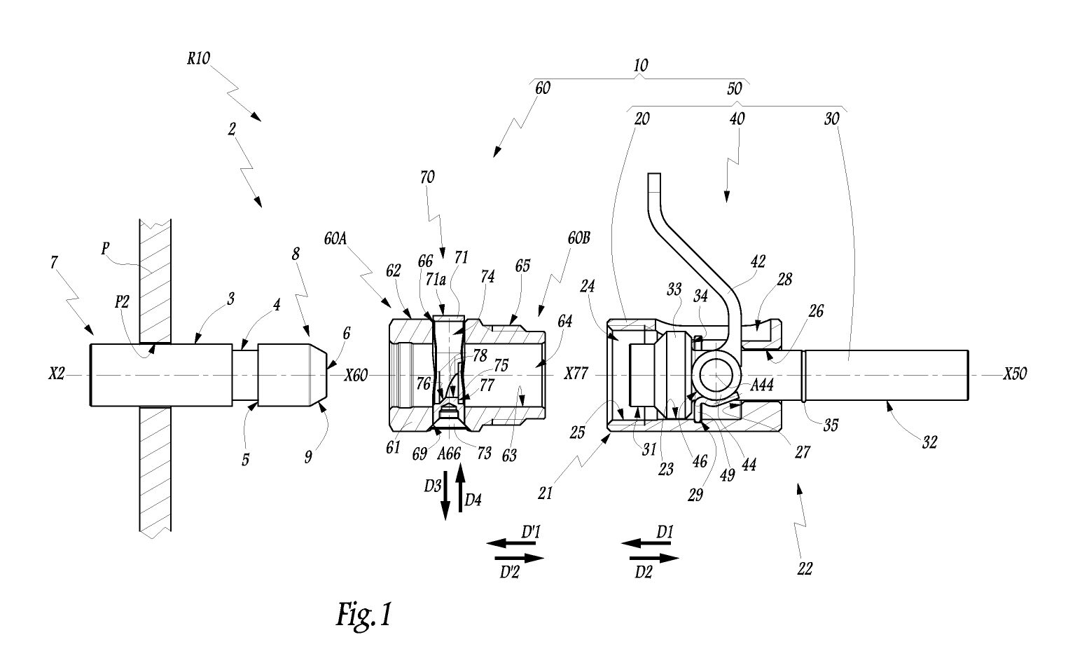

FIG. 1 is a partial axial section of a coupling according to the invention, including a coupling device and a male coupling end piece shown in a uncoupled configuration, the device being also according to the invention and consisting of a female coupling end piece and an intermediate connecting member, which are adapted for receiving the male coupling end piece and illustrated in a uncoupled configuration;

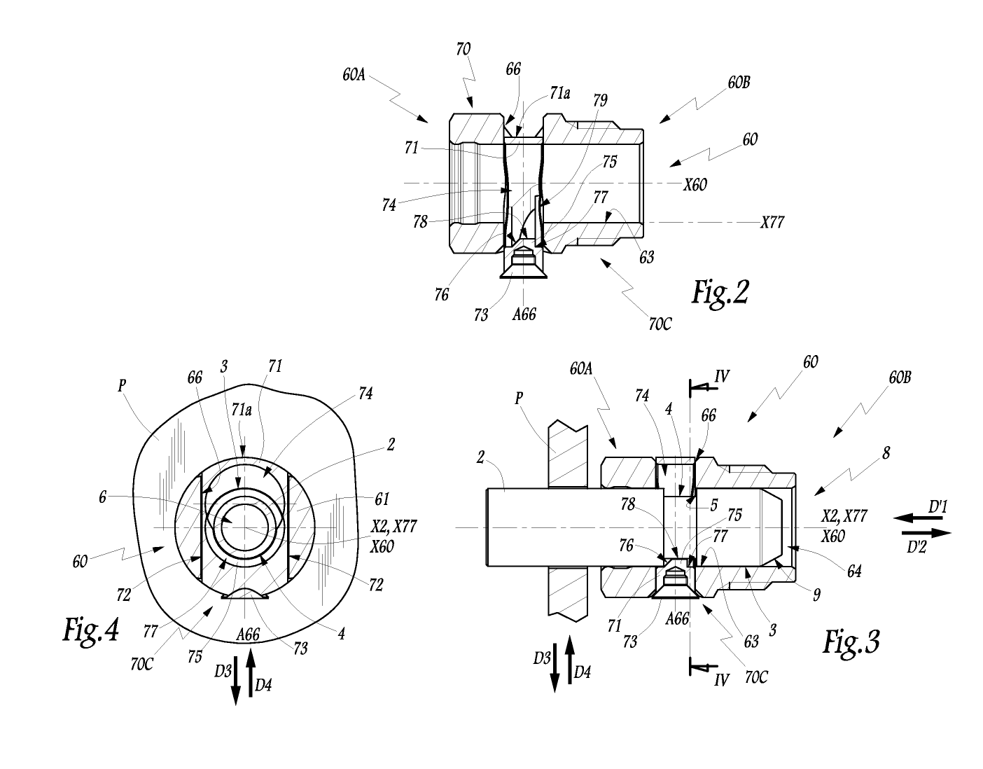

FIG. 2 is a partial section similar to FIG. 1, at a larger scale, showing only the intermediate member with the locking mechanism thereof in an unlocked configuration;

FIG. 3 is a partial section similar to FIG. 1, at a larger scale, showing the male coupling end piece and the intermediate member of the coupling device during the coupling operation;

FIG. 4 is a section along line IV-IV of FIG. 3;

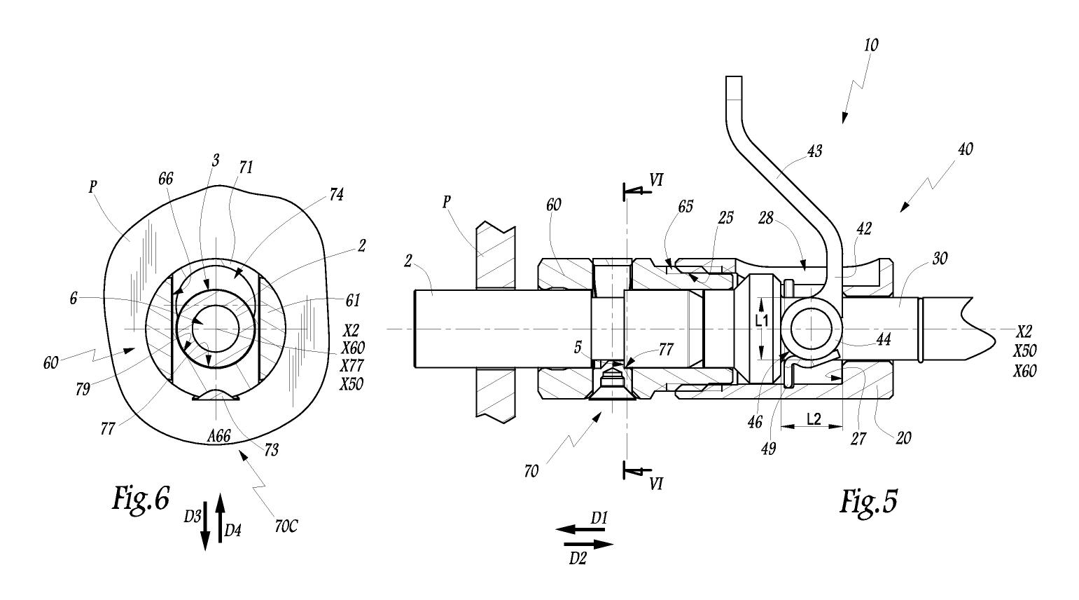

FIG. 5 is a partial section similar to FIG. 3, showing the female coupling end piece during the coupling operation with the intermediate member being coupled with the male coupling end piece;

FIG. 6 is a section along line VI-VI of FIG. 5;

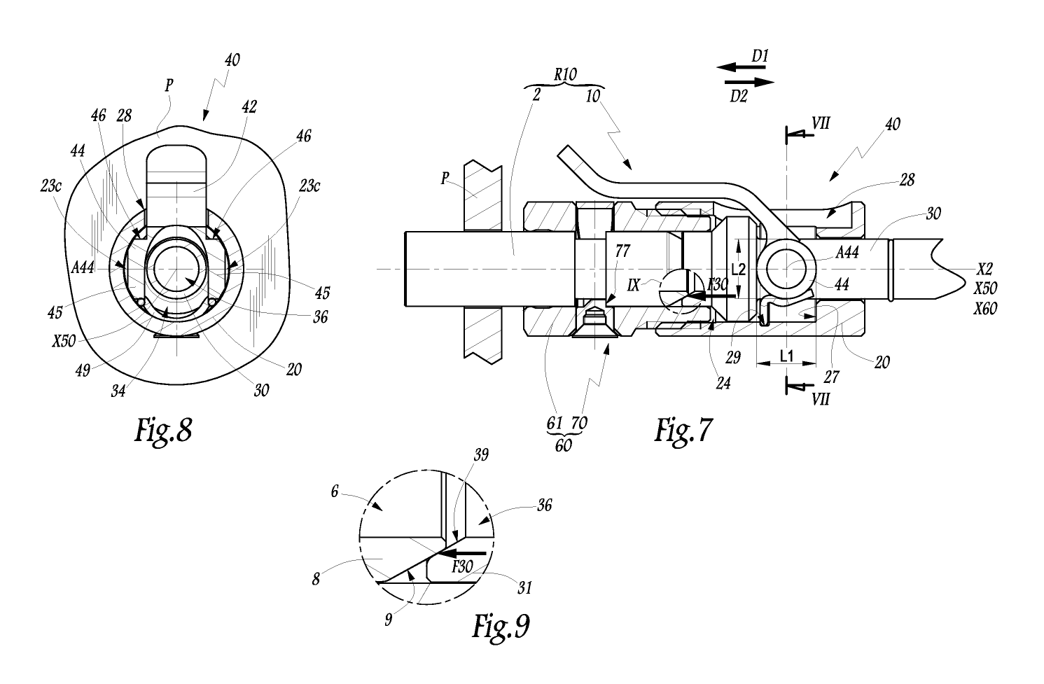

FIG. 7 is a partial section similar to FIG. 5, showing the connector in a coupled configuration;

FIG. 8 is a section along line VIII-VIII of FIG. 7;

FIG. 9 is a view at a larger scale of detail IX of FIG. 7;

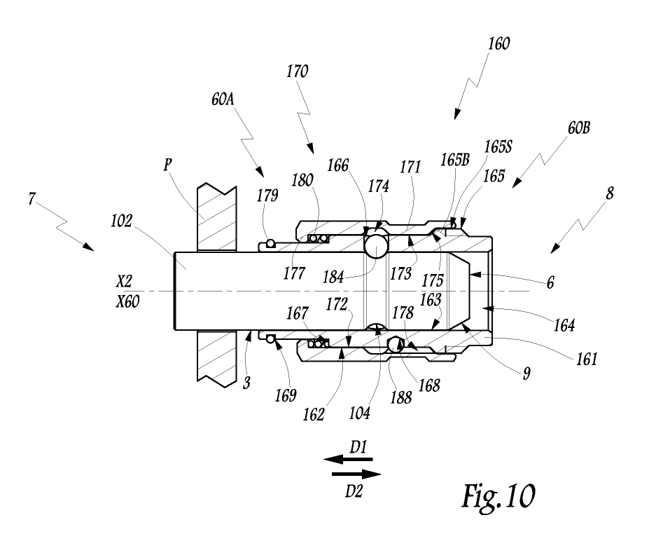

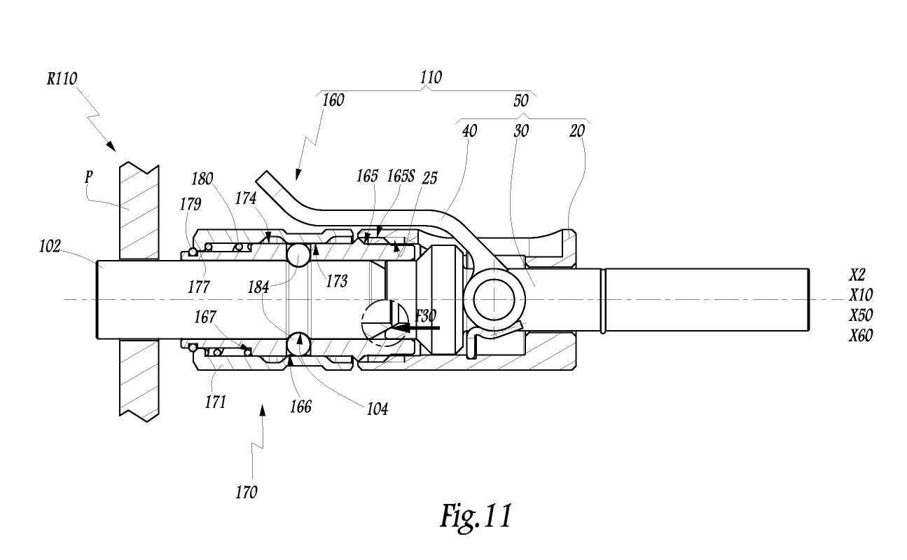

FIGS. 10 and 11 are sections respectively similar to FIGS. 3 and 7, for a second embodiment of a coupling and connector device in accordance to the invention, including an intermediate member provided with a ball locking mechanism.

In FIGS. 1 to 9, a first embodiment of a connector R10 including a coupling device 10 and a tube 2 shaped as a male element or coupling end piece is represented.

This device 10 is shaped as a female coupling element, suitable for receiving tube 2. Device 10 and tube 2 are the two components of connector R10 suitable for transferring gaseous and/or liquid fluids at high temperatures and high pressures when the connector R10 is in a coupled configuration, shown in FIGS. 7 to 9. In this case, device 10 is connected to a first pipe, while tube 2 is coupled with coupling device 10 and connected to a second pipe, such pipes being not represented in FIGS. 1 to 9 for the sake of simplicity.

The components of connector R10 are metallic so as to withstand high temperatures and high pressures.

Tube 2 includes an external surface of revolution 3 which is centered about a longitudinal axis X2 and extends between two longitudinal ends 7 and 8 of tube 2. Tube 2 is inserted into an orifice P2 made in a plate P. Surface 3 is fitted into the orifice P2, while the ends 7 and 8 are located on either side of the plate P. End 7 is connected to the pipe, not shown, and fastened to a structure, also not shown, while the connecting end 8 is provided to be coupled with device 10. In the section thereof which is arranged on the side of end 8 with respect to plate P, surface 3 is provided with an annular groove 4 having a flat bottom centered about axis X2. The groove 4 is closer to end 8 than end 7. In the part thereof arranged on the side of end 8 with respect to plate P, radial space requirement of tube 2 is smaller than the radial dimensions of orifice P2. In this case, the external surface 3 has the same diameter on either side of groove 4. Groove 4 has a shoulder 5 which is located on the side of end 8, is perpendicular to axis X2, and is oriented toward plate P and end 7. Shoulder 5 connects the bottom of groove 4 to surface 3. An internal channel 6 is made in tube 2 and opens at both ends 7 and 8 of tube 2. End 8 has a truncated cone-shaped external surface 9 centered about axis X2. The diameter of the surface 9 decreases as it moves away from end 7. The frustoconical surface 9 is a bearing portion for a complementary frustoconical surface 39 belonging to device 10, as shown in FIG. 9. Such frustoconical sealing by metal to metal contact is well adapted for fluids at high temperatures and high pressures. Also, sealing by truncated cone to truncated cone does not require any seal, whereby maintenance is simplified.

The device 10 includes a coupling end piece 50 and an intermediate connecting member 60. End 50 extends along an axis X50 and member 60 extends along an axis X60. Axes X50 and X60 coincide in the coupled configuration of device 10.

Coupling end piece 50 consists of a tapped end piece ring 20, an end piece body 30 movable with respect to ring 20, and a mechanism 40 for displacing the body 30 with respect to the ring 20 along axis X50.

The tapped end piece ring 20 has a generally tubular shape. The ring 20 extends along axis X50 between one end 21 connecting to member 60 and one end 22 for sliding the body 30 along axis X50. The ring 20 includes a first bore 23 which is located on the side of end 21, and a second bore 26 which is located on the side of end 22. These two bores 23 and 26 delimit a so-called dry inner cavity 24 in that this cavity 24 is isolated from the flow channel of the fluid circulating inside device 10. This cavity 24 goes entirely through the ring 20 along the longitudinal axis X50. The ring 20 includes a gripping profile 25, which in fact is an inner thread, i.e. an internal thread, made about axis X50 at the radial surface of the first bore 23 on the side of end 21. The body 30 can translate along axis X50 with respect to the end piece ring 20 by being guided inside bore 26. The diameter of bore 23 is greater than the diameter of bore 26, these diameters being measured around axis X50. These two bores 23 and 26 are connected inside the cavity 24 by a shoulder 27 which is perpendicular to axis X50.

The ring 20 also includes a transverse opening 28 and a partial annular groove 29, as it opens into the radial opening 28, which are provided for receiving different components of the mechanism 40. Opening 28 goes through the ring 20 between bore 23 and the outer surface of ring 20 radially with respect to axis X50. This opening 28 is blind. As shown in FIG. 8, bore 23 of ring 20 delimits lateral housings 23c made on either side of axis X50 and a plane of symmetry of the opening 28, said plane of symmetry corresponding to the plane of FIG. 7. Groove 29 is made in the bore 23 and centered about axis X50.

For the end piece ring 20, a forward direction D1 is defined, parallel to axis X50 and directed from end 22 to end 21. For the end piece ring 20, a direction D2 is also defined, oriented opposite direction D1.

The end piece body 30 includes a front portion 31 connecting to tube 2 and a rear portion 32 connected to the pipe, not shown. The front portion 31 and the rear portion 32 each have a tubular shape centered about axis X50 and are separated by a generally annular protruding collar 33. The front portion 31 and the collar 33 are housed in the bore 23, while portion 32 extends from bore 23 toward the outside and the rear portion 22 of ring 20 by going through bore 26. In other words, body 30 partially penetrates into ring 20 without being surrounded by fluid. Collar 33 has a rear shoulder 34 forming a bearing stop of the mechanism 40, as explained below. The rear portion 32 of body 30 includes a rear stop 35 protruding from the external surface thereof. Furthermore, displacement of the body 30 in the direction D2 with respect to the end piece ring 20 is limited by the presence of collar 33 and mechanism 40.

As shown in FIGS. 7 to 9, end piece body 30 also includes an internal channel 36, partially delimiting the main fluid flow channel in coupling device 10. Channel 36 extends through body 30 along longitudinal axis X50 and opens at front portion 31 and rear portion 32. The frustoconical surface 39 is made at the orifice of channel 36, toward the inside of the front portion 31 and on the side of the front end of portion 31. The frustoconical surface 39 is flared toward the front end of portion 31, thus forming a bearing portion complementary to surface 9 of tube 2.

The mechanism 40 for displacing the end piece body 30 includes a cam lever 42 clevis-mounted around the body 30. The lever 42 includes an actuating arm 43 extending through opening 28 provided therefore in ring 20 and can be actuated by an operator from the outside of the end piece ring 20. The lever 42 includes a cam 44, provided with lateral portions 45 which are partially housed in the lateral housings 23c of ring 20, as shown in FIG. 8. Each lateral portion 45 has an outer surface 46 which is generally oval in cross-section in a plane parallel to the plane of FIG. 5. The two surfaces 46 are symmetrical with respect to the plane of symmetry of lever 42 corresponding to the plane of FIGS. 1, 5, and 7. Each surface 46 defines a locking width L1 and an unlocking width L2, as shown in FIGS. 5 and 7, with width L1 being greater than width L2. In this sample embodiment, the lengths L1 and L2 are defined in directions perpendicular to each other. By way of a non-restrictive example, the dimensional difference between the locking width L1 and the unlocking width L2 of the cam 44 is on the order of 0.05 mm, for a width L1 which is on the order of 4 mm. More generally, the dimensional difference between the widths L1 and L2 is on the order of 0.5% to 5%, preferably on the order of 1%. The cam 44 is capable of pivoting about an axis A44, perpendicular to the plane of symmetry of lever 42, when the operator actuates the lever 42.

When the device 10 is in the uncoupled configuration, the mechanism 40 is in a so-called unlocked position. The arm 43 extends through the opening 28, substantially perpendicularly to axis X50, as shown in FIGS. 1 and 5. During the coupling operation, the lever 42 can be folded back by the operator into a locking position, with the arm 43 which is positioned substantially in parallel to axis X50 and extends toward the front of the coupling end piece 50 as shown in FIGS. 7 and 8. The cam 44 then pushes back the body 30 as explained here-after.

Through the action of the mechanism 40 during the coupling operation, the body 30 is thus movable inside the ring 20 between, on the one hand, a position recessed upon contact of the cam 44 in direction D2 and, on the other hand, a position advanced toward the end 21 of the ring 20 under the thrust of the cam 44 in direction D1. When the device 10 is coupled with the intermediate member 60 which is screwed to the end piece 50, portion 31 of body 30 penetrates into member 60. When the device 10 is removed, displacement of body 30 in direction D1 is limited by stop 35 which comes into abutment against the end piece ring 20. The body 30 is represented in the recessed position upon contact of the cam 44 in FIG. 1, but could alternatively be represented in the position advanced toward the front portion 31, with the stop 35 limiting the displacement thereof. In the recessed position of body 30 inside the end piece ring 20, the collar 33 of body 30 is touching the cam 44, which in turn is held in the contact position inside the ring 20, with the lateral portions 45 bearing on the shoulder 27 in the lateral housings 23c.

The mechanism 40 also includes a brake spring 49 suitable for frictionally holding the cam lever 42 in an angular locking and unlocking position when the operator does not act upon the lever 42. The brake spring 49, on the one hand, is partially housed in the groove 29 of ring 20 and, on the other hand, partially extends against the outer surfaces 46 of cam 44, on the side radially opposite opening 28 and arm 43 with respect to axes X50 and A44.

The intermediate member 60 includes a tubular body 61 and a quick locking mechanism or latch 70. The tubular body 61 includes a generally cylindrical radial external surface 62, as well as an internal bore 63, which are centered about axis X60. The bore 63 delimits a so-called dry inner cavity 64 in that this cavity 64 is isolated from the flow channel of the fluid circulating inside the device 10, like cavity 24 of ring 20. A transverse groove 66 goes entirely through the body 61 along an axis A66 perpendicular to axis X60 opening into the cavity 64 and at surface 62. The groove 66 is provided for receiving the latch 70, as will be explained below. Surface 62 has a gripping profile 65, which is more precisely a peripheral external thread, complementary to the internal thread 25 and made around axis X60. The external thread 65 is located along axis X60 and with respect to the groove 66, on one side 60B of the member 60. During the coupling operation between end piece 50 and member 60, the side 60B and the external thread 65 are oriented toward the end piece 50. The external thread 65 is thus capable of engaging the internal thread 25 of the tapped ring 20, as shown in particular in FIG. 5. The member 60 also includes one side 60A, opposite side 60B with respect to the groove 66 and along axis X60. Tube 2 can be introduced into the cavity 64 from this side 60A.

For the intermediate connecting member 60, a forward direction D′1 is defined, oriented along axis X60 from side 60B to side 60A. A direction D′2 is also defined for the intermediate connecting member 60 in a direction opposite direction D′1. When the intermediate connecting member 60 and the coupling end piece 50 are being coupled or mated, directions D′1 and D′2 for the intermediate connecting member 60 are respectively identical to directions D1 and D2 for the end piece ring 20.

The latch 70 includes a rigid slide 71 having a cross-section complementary to the cross-section of groove 66, except for functional play, provided with two lateral surfaces 72. Surfaces 72 are located on either side of axis X60 and axis A66. The operator may actuate the slide 71 by pressing an outer surface 71a of said slide 71. A screw 73 is fastened on a radial outer side 70C opposite surface 71a of slide 71, with a screw axis extending substantially along axis A66. The slide 71 is movable along axis A66 in a sliding connection inside the groove 66 of member 60 at the surfaces 72. More precisely, the slide 71 is movable inside groove 66, on the one hand, along a direction of disengagement D3 oriented along axis A66 toward side 70C, in particular by the action of the operator on the surface 71a up to a stop, not shown, and, on the other hand, along a direction of engagement D4 opposite direction D3, by the action of a return spring, not shown for the sake of simplicity. The return spring integrated into latch 70 tends to bring the slide 71 back into the position of abutment, shown in FIG. 1, in the direction D4 of disengagement or return. The groove 66 is provided with a conical surface 69, which is the stop of latch 70 in the direction D4 by abutment of screw 73 against the conical surface 69.

Directions D3 and D4 are radial to axis X60, i.e. perpendicular to directions D′1 and D′2.

A housing 74 is made in the slide 71 of latch 70, opening on either side of the slide 71 in parallel to axis X60. The housing 74 is generally elongated in direction D4. On side 70C, the housing 74 is provided with a radial detachment 75 oriented toward axis X60. More precisely, the detachment 75 has an inclined surface 76, a safety counterbore 77, and a tooth 78. The surface 76 is turned toward side 60A and axis X60 while the counterbore 77 is arranged on side 60B, with the tooth 78 being arranged along axis X60 between surface 76 and counterbore 77. Due to the elongated geometry of the housing 74, the counterbore 77 is in fact a partial cylindrical counterbore, centered about an axis X77 parallel to axis X60 the external diameter of which is substantially equivalent to the diameter of the external cylindrical surface 3 of tube 2. Said counterbore 77 covers an angular sector 79 strictly greater than 180°, preferably greater than 200°, in this case equal to 210° in the embodiment of FIGS. 1 to 9. The angular sector 79 covered by the counterbore 77 is arranged on side 70C and is defined about the center axis X77 of the counterbore 77. Axis X77, on the one hand, is aligned with axis X60 in the position blocking tube 2 introduced into the member 60, as shown in FIGS. 3 and 4 and, on the other hand, offset on the side 70C with respect to axis X60 in the position releasing tube 2 from the intermediate member 60, as shown in FIG. 2.

In practice, tube 2 is inserted into cavity 64 and through housing 74 of the member 60 to be connected to end piece 50. The latch 70 then allows for quick locking of tube 2 inside member 60, as will be explained below. More precisely, the latch 70 allows for blocking tube 2 in translation in direction D′1 when tube 2 and the intermediate connecting member 60 are coupled. In this case, the latch 70 is partially housed inside the groove 4 with detachment 75 coming into the annular groove 4 to contact the external surface 3 of tube 2. The shoulder 5 of tube 2 comes into abutment against the tooth 78 at the bottom of the safety counterbore 77. Locking is said to be quick in that it is done without any screwing operation between tube 2 and member 60. Furthermore, when tube 2 is blocked inside member 60, a rotational movement of member 60 around tube 2 is possible, in particular for screwing the external thread 65 with the internal thread 25.

The complete operation of connector R10 and device 10 will be explained below.

Initially, tube 2, coupling end piece 50, and intermediate member 60 are uncoupled, as shown in FIG. 1.

In a first connecting step shown in FIGS. 2 to 4, the operator implements the quick-latch connection 70 so as to connect the intermediate member 60 to tube 2. The end 8 of tube 2 is introduced into cavity 64 through the front side 60A. Surface 3 is substantially fitted into the bore 63, while axes X2 and X60 are substantially aligned. Surface 3 will come into abutment against the inclined surface 76, transversely pushing back the slide 71 of latch 70 in direction D3, against the return spring. When the radial detachment 75 is located opposite groove 4 and tube 2 has been sufficiently inserted for the shoulder 5 of the groove 4 to be beyond the counterbore 77 in direction D′2, the slide 71 is pushed back resiliently in direction D4 by the spring of latch 70, with the tooth 78 engaging the groove 4, as shown in FIGS. 3 and 4. Thus, at this point, the shoulder 5 is not in abutment against the counterbore 77.

Furthermore, a movement of tube 2 with respect to member 60 is, on the one hand, possible in rotation about axis X2 and, on the other hand, blocked in translation in direction D′1 , provided the shoulder 5 comes into abutment against the tooth 78 in the counterbore 77.

The connection between tube 2 and intermediate member 60 is said to be automatic, in that it is performed by the mere movement of introducing tube 2 into the intermediate member 60.

In a second connecting step shown in FIGS. 5 and 6, the operator engages the internal thread 25 of the end piece ring 20 into the external peripheral thread 65 of member 60, then screws this member 60 down until direct contact is established between the frustoconical surface 9 of tube 2 and the frustoconical surface 39 of the end piece body 30. In this configuration during the coupling operation, the body 61 is then housed with side 60B thereof inside cavity 24, the front portion 31 of the body 30 is substantially fitted into the bore 63, while axes X2, X50 and X60 are substantially aligned. Screwing between the gripping profiles 25 and 65 will continue as long as, on the one hand, in direction D1, tube 2 is not in abutment in the safety counterbore 77 of latch 70 and, on the other hand, in direction D2, the body 30 does not contact the end piece ring 20 via the cam lever 42. More precisely, the shoulder 34 of collar 33 is pushed back against the surfaces 46 of the cam 44 while at the same time, the surfaces 46 of cam 44 are pushed back bearing on shoulder 27, inside the lateral housings 23c made in the ring 20. In the unlocked position of lever 42, the cam 44 is thus interposed along the longitudinal axis X50 between the end piece body 30 and the end piece ring 20 which is made longitudinally integral with tube 2, at the unlocking width L2 thereof. Due to the engagement of tube 2 into counterbore 77, the movement of the latch in direction D4 for disengaging the latch 70 and thus withdrawing the tube 2 from the member 60 is now prevented by the geometry of the counterbore 77 and the angular sector 79 thereof, with tube 2 being a stop for the displacement of the latch 70 in direction D4.

Thus, the screwed connection between ring 20 and member 60 allows for axial manufacturing end play and tolerances of the components of connector R10 to be compensated and the coupling between tube 2 and intermediate connecting member 60 to be secured.

In a third connecting step shown in FIGS. 7 to 9, the operator actuates the mechanism 40. More precisely, the operator pivots the arm 43 of lever 42 toward the front end 21 of the ring 20 until said arm 43 is substantially parallel to axis X50 in the locking position thereof. The surfaces 46 of the cam 44 are pivoted into abutment against the shoulder 27, while the surfaces 46 are made to slide against the shoulder 34 of the collar 33. The cam 44 is then sandwiched along the longitudinal axis X50 between the end piece body 30 and the end piece ring 20 at the locking width L1, thus pushing back the collar 33 in direction D1 with respect to the end piece ring 20. In other words, after installation and compensation of axial play, actuating lever 42 will cause displacement of the end piece body 30 with respect to the end piece ring 20 in direction D1 toward tube 2, said displacement being equal to the difference between the widths L1 and L2, preferably on the order of 5 hundredths millimeters. When the body 30 is translated with respect to tube 2, surface 39 will apply forces F30 directed in direction D1 to surface 9. Forces F30 are distributed radially about the coinciding axes X2 and X50, at the interface between surfaces 9 and 39. Such forces F30 ensure optimal tightening of the frustoconical surfaces 9 and 39 together, thereby creating sealing between tube 2 and end piece body 30. In this coupled configuration, stop 35 does not touch the ring 20 so as not to interfere with the translation of body 30.

At this point, connector R10 and device 10 are in the coupled configuration. The fluid can circulate through the connector R10, more precisely through end piece body 30 and tube 2, in channels 36 and 6. The cam lever 42 is held in the position locking the parts by means of the brake spring 49.

In a disconnecting step, the operator brings back lever 42 into the upright unlocking position, with the arm 43 extending substantially radially to axis X50, and cam 44 being inserted along longitudinal axis X50 between the end piece body and the end piece ring at the unlocking width L2 thereof. Forces F30 are released. Then, the operator unscrews the intermediate member 60 so as to take down the coupling end piece 50.

If required, for removing tube 2 through plate P, said tube 2 must be uncoupled from the intermediate member 60. For this purpose, the operator displaces tube 2 in direction D2 with respect to the intermediate member 60 so that the shoulder 5 of tube 2 exits the safety counterbore 77. When the operator presses the surface 71a, slide 71 slides in direction D3, against the resilient force of the spring of latch 70 and the radial detachment 75 thereof retracts from the groove 4, as shown in FIG. 2 where only member 60 is represented for the sake of simplicity. Tube 2 is then released by latch 70 and may slide inside the housing 74 without being blocked by latch 70, and can then be extracted from member 60. Tube 2 can then be withdrawn through orifice P2 of plate P. As soon as the operator releases action on the latch 70, the latch 70 is resiliently returned in direction D4 and ready for a new connection of a tube 2 type element.

According to the invention, latch 70 is thus movable between, on the one hand, a position blocking the coupling element 2 introduced into the intermediate member 60, at least in the forward direction D1, with respect to the body 61 of the intermediate member 60 and, on the other hand, a position releasing the coupling element 2, which can then be withdrawn from the intermediate member 60 in direction D1.

In FIGS. 10 and 11, a second embodiment of a connector R110 and coupling device 110 according to the invention is represented.

Some components of the connector R110 are identical with components of the connector R10 of the first embodiment, described above, and carry the same reference numbers.

Other components of connector R110 exhibit similar operation, but are different in structure, in comparison with the first embodiment, and carry reference numbers increased by 100. This is the case for tube 102, groove 104, intermediate member 160, tubular body 161, an external surface 162, an internal bore 163, an inner cavity 164, an external thread 165, several transverse grooves 166 radially distributed about axis 60, as well as for a quick-lock mechanism 170.

Tube 102 is similar to tube 2, except for groove 104. This groove 104 has an annular profile with a rounded concave bottom centered about axis X2.

The mechanism 170 fitting the intermediate member 160 is a ball latch. More precisely, the latch 170 has rigid locking balls 184 arranged in the radial grooves 166 and capable of being partially housed inside groove 104, upon contact of an external surface of tube 102. Thus, the balls 184 can prevent any relative translatory displacement between tube 102 and body 161 of member 160, while allowing for rotation of member 160 around tube 102. In the example of FIGS. 10 and 11, there are six balls 184 and grooves 166. In FIG. 10, the section is a different sectional plane on either side of axis X60. Alternatively, the number of balls 184 and grooves 166 can be other than six.

The latch 170 includes a locking ring 171 having a generally tubular shape. The ring 171 has a bore 172 in sliding connection, in directions D′1 or D′2, on the external surface 162 of body 161. The bore 172 has a portion 173 capable of affecting the balls 184 along a direction of engagement oriented toward axis X60 so as to hold said balls 184 inside the groove 104. Bore 172 also has an internal groove 174 which, when positioned opposite grooves 166, will receive balls 184 so as to extract them from the groove 104. The bore 172 also has a surface 175, oriented on side 60B, bearing on a longitudinal stop 165B made on side 60A of the external thread 165.

Ring 171 also includes a detachment 177, radially oriented toward axis X60 with respect to the bore 172 and which is the end of the ring 171 on side 60A. A spring 180 is positioned about axis X60 between the body 161 and the ring 171. More precisely, the spring 180 is arranged between the detachment 177 and a shoulder 167 made in the body 161 and turned to side 60A. The spring 180 tends to push back the ring 171 into a position where portion 173 is covering the grooves 166.

Ring 171 also includes longitudinal grooves 178 opening at the bore 172 opposite the housings 168 made in body 161. The housings 168 and grooves 178 will receive the balls 188, provided to be integral in rotation of ring 171 with the body 161. Furthermore, an annular seal 179 is housed in an annular groove 169 made at the surface 162 of the body 161 on side 60A. Thus, during longitudinal sliding displacements of the ring 171 around the body 161, the detachment 177 will come into abutment in direction D′1 against the seal 179, or the surface 175 will come into abutment in direction D′2 against the stop 165B.

Operation of the connector R110 and the device 110 will be explained hereafter. This operation is comparable to that of connector R10 and device 10 except for the first connecting step.

As shown in FIG. 10, in this first connecting step, the operator implements the quick ball latch connection 170 so as to block the tube 102 inside the intermediate member 160. The operator pushes the ring 171 back against the stop 165B in direction D′2, counteracting spring 180. The end 8 of tube 102 is introduced into the cavity 164 through the front side 60A, in direction D′2. The groove 174 is then located opposite grooves 166, while the ring 171 is partially covering the external thread 165 of the member 160 over a cover surface 165S. Balls 184 will roll over the surface 3, while balls 188 housed in the housings 168 will roll inside the grooves 178. The frustoconical surface 9 pushes the balls 184 back into grooves 166 and groove 174, in a direction of disengagement moving away from the axis X60. The displacement of tube 102 in the direction D′2 continues until the balls 184 are positioned opposite groove 104.

At this point, the operator releases the ring 171, which is pushed back by the spring 180 in direction D′1. Balls 184 are then housed inside this groove 104, as shown in FIG. 10. Portion 173 of bore 172 is positioned opposite grooves 166, so as to prevent any radially outward displacement of balls 184, as shown in FIG. 11. A movement of tube 102 with respect to member 160 is then, on the one hand, possible in rotation about axis X2 and, on the other hand, prevented in translation in direction D′1 and direction D′2, with balls 184 being held inside the transverse grooves 166 and groove 104 by the ring 171. Unlike in the first embodiment described above, the latch 170 prevents any translatory displacement in the two directions D′1 and D′2.

The second and third connecting steps, which allow for the connector R110 and device 110 to be brought into a coupled configuration, are identical with those described above for connector R10 and device 10. Since the member 160 and the coupling end piece 150 have been mounted and axial play has been compensated, the external thread 25 at least partially covers the surface 165S and, consequently, the ring 171 cannot be brought into the ball unlocking position 184. Then, tube 102 and the intermediate connecting member 160 cannot be uncoupled.

In a disconnecting step, the operator brings back the lever 42 into the unlocked position. Then, the operator unscrews the intermediate member 160 so as to remove it from the coupling end piece 50.

If required, for removal of tube 102 through plate P, said tube 2 must be disconnected from the intermediate member 160. The cover surface 165S being disengaged, the operator can push back the ring 171 in the direction D′2, against the stop 165B. The surface 174 is then located radially opposite balls 184 so as to release them from the groove 104 and release the male element 102 which can then be withdrawn from the intermediate member 160. The operator can thus apply a withdrawal force to the tube 102 of cavity 164 of member 160 thereby disengaging the balls 184 from the groove 104 in a disengaging movement transverse to the axis X60, and releasing the male element which can then be withdrawn from the intermediate member 160, then the ring 171 is released.

The components of connector R10 or R110 and coupling device 10 or 110 can be shaped in different ways without departing from the scope of the invention. In practice, said components are designed to ensure a reliable sealing connection which can be made conveniently and resist to several operations of installing and removing the coupling.

In a variant, not shown, the quick lock mechanism can be configured in a different way from mechanisms 70 and 170, while allowing for the connection between the intermediate member and the tube to be made simply and fast. E.g., the coupling device can include a locking mechanism with fingers or claws coming into abutment on an external surface of the tube. The engagement of a locking mechanism inside a groove of the tube ensures that after locking, the intermediate member may turn with respect to the tube and that screwing thereof into the end piece ring does not apply any torsional stress to the pipe connected to the tube. Furthermore, the locking mechanism is suitable to be brought into the blocking position thereof while the intermediate member is uncoupled from the end piece ring 20.

The variants below are described with reference to device 10 for the sake of simplicity, knowing that they are also applicable to device 110.

In a variant, not shown, the bearing portions 9 and 39 between tube 2 and end piece body 30 can be shaped differently from the example of FIGS. 1 to 11. Preferably, the portions 9 and 39 include at least one frustoconical surface for sealing contact. E.g., either one of portions 9 and 39 includes a frustoconical surface and a spherical surface in sealing contact. According to another example, portions 9 and 39 can be configured with tube 2 which is female and receives a male end piece body 30. Preferably, when the sealing contact of the portions 9 and 39 is of the type truncated cone to sphere, the female external part is provided with a truncated cone end and the male internal part is provided with a spherical end.

According to another variant, not shown, the sealing within the coupling 10 is ensured by a metal seal. More precisely, the sealing contact between tube 2 and end piece body 30 is ensured by means of a metal seal, which is compressed in that the parts are moved closer by the lever 42 being actuated, between the bearing portions 9 and 39 of the tube 2 and the end piece body 30 for sealing the connection. In this case, the bearing portions 9 and 39 of tube 2 and end piece body 30 are not necessarily frustoconical or spherical surfaces.

According to another variant, not shown, the end piece ring 20 includes a male gripping profile, e.g. an external thread, while the intermediate member 60 includes a female gripping profile, e.g. an internal thread.

According to another variant, not shown, the mechanism 40 can be shaped differently, adapted to the current application. E.g., the cam 44 and the outer surfaces 46 thereof can be shaped differently from what is represented in FIGS. 1 to 11. According to another example, the lever 42 is not made of one piece. Preferably, the mechanism 40 includes a rotating portion generating a longitudinal displacement of the body 30, in particular in the forward direction D1.

Advantageously, the displacing mechanism 40 causes the two bearing portions 9 and 39 to be moved closer together, while the bearing portion 9 is already in abutment against the end piece body 30, whereby the sealing contact within the device is established to ensure the sealing coupling of the two pipes.

According to another variant, not shown, the end piece body 30 is not shaped as a one-piece tubular body, but consists of several parts mounted together in a sealing manner.

According to another variant, not shown, a valve system can be arranged inside tube 2 and/or inside the main fluid flow channel defined by the end piece body 30. At any rate, the ring 20 includes a dry inner through-cavity 24 isolated from the fluid stream, i.e. where there is no direct fluid circulation.

Whatever the embodiment, no fluid flows inside the dry cavity 24 of the ring 20 and over the outer surface of the body 30. In other words, the body 30 is different from a valve.

In as far as from the coupled configuration of connector R10, the tube 2 cannot be split from the coupling end piece 50 without prior removal of the coupling end piece 50 and the intermediate member 60, sealing of an element like the tube 2 and the end piece body 30 is ensured during subsequent connection.

Furthermore, the technical specifications of the various embodiments can be combined together, for all or some of them. Thus, the coupling and coupling device according to the invention can be adapted to a specific application, in particular in terms of operating cost and conditions.

1. A coupling device (10; 110), adapted to transfer pressurized fluids, said coupling device (10; 110) being connected to a first pipe and configured for coupling with a coupling element (2; 102) connected to a second pipe, with a first part (2; 102) among the coupling device and the coupling element that is configured as a male element and a second part (10; 210) among the coupling device and the coupling element that is configured as a female element, the coupling device (10; 110) including:
an end piece body (30) having a bearing portion (39) and delimiting an internal flow channel (36) of a fluid in the coupling device (10; 110), the end piece body (30) being connected to the first pipe,
an end piece ring (20) provided with an inner cavity (24) which extends generally along a longitudinal axis (X50) and which is isolated from the internal flow channel (36) for the fluid, and with a radial surface (23) having an external thread (25), and
displacement means (40) for displacing the end piece body (30), in at least one forward direction (D1) parallel to the longitudinal axis (X50) of the end piece ring (20), inside the inner cavity (24) of the end piece ring (20),
wherein the coupling device (10; 110) also includes an intermediate member (60; 160) having:
a body (61; 161) which extends along a longitudinal axis (X60) and which is provided with a radial surface (62) having an external thread (65; 165) complementary to the external thread (25) of the end piece ring (20), and
a locking mechanism (70; 170) movable between, on the one hand, a blocking position for blocking the coupling element (2; 102) introduced into the intermediate member (60; 160) with respect to the intermediate member (60; 160), in at least one forward direction (D′1) parallel to the longitudinal axis (X60) of the body (61) and, on the other hand, a position where the locking mechanism (70;170) allows for the coupling element (2;102) to be withdrawn from the intermediate member (60;160),
wherein the locking mechanism (70; 170) is able to be located in the blocking position thereof while the intermediate member (60; 160) is uncoupled from the end piece ring (20), and wherein the bearing portion (39) of the end piece body (30) is capable of coming into sealing contact with the coupling element (2; 102) for sealingly coupling the first and second pipes.

2. The coupling (10; 110) according to claim 1, wherein the locking mechanism (70; 170) is capable of being housed at least partially inside a groove (4; 104) made in the coupling element (2; 102).

3. The coupling device (10; 110) according to claim 1, wherein the displacement means (40) for displacing the end piece body (30) include a lever (42) and a cam (44) pivoting in the end piece ring (20).

4. The coupling device (10; 110) according to claim 3, wherein the lever (42) is clevis-mounted around the end piece body (30), the cam (44) being interposed along the longitudinal axis (X50) of the end piece ring (20) between a shoulder (34) of the end piece body (30) and a shoulder (27) of the end piece ring (20).

5. The coupling device (10; 110) according to claim 3, wherein the cam (44) has at least one outer surface (46), with a locking width (L1) and a unlocking width (L2) which is smaller than the locking width (L1), a difference between the locking width (L1) and the unlocking width (L2) being preferably on the order of 0.5% to 5%.

6. The coupling device (10; 110) according to claim 3, wherein the displacement means (40) also include a brake spring (49) arranged between the end piece ring (20) and the lever (42) and capable of holding the lever (42) in an angular locking and/or unlocking position.

7. The coupling device (10; 110) according to claim 1, wherein the end piece ring (20) includes an internal thread (25) made at the inner cavity (24), while the intermediate member (60; 160) includes, on an external cylindrical surface (62; 162) of the body (61; 161), an external thread (65; 165) complementary to the internal thread (25).

8. The coupling device (10) according to claim 1, wherein the locking mechanism (70) includes a slide (71) which is movable perpendicularly to the longitudinal axis (X60) of the body (61) of the intermediate member (60) and which has a housing (74) traversed by the coupling element (2) when the latter is introduced into the intermediate member (60), said housing being provided with a radial detachment (75) for blocking the coupling element (2) in the forward direction (D′1).

9. The coupling device (10) according to claim 8, wherein the slide (71) includes a safety counterbore (77) capable of receiving the coupling element (2) in abutment in the forward direction (D′1), said safety counterbore (77) covering an angular sector (79) of at least 200° about a center axis (X77) of the safety counterbore (77).

10. The coupling device (110) according to claim 1, wherein the locking mechanism (170) includes:
locking balls (184), and
a ring (171) movable in parallel to the longitudinal axis (X60) of the body (161) of the intermediate member (160) around the body (161) between, on the one hand, a position for locking the balls (184) in the coupling element (102) so as to block the coupling element (102) with respect to the intermediate member (160) and, on the other hand, a position for releasing the balls (184) for withdrawal of the coupling element (102) from the intermediate member (160).

11. The coupling device (110) according to claim 10, wherein the end piece ring (20) includes an internal thread (25) made at the inner cavity (24), while the intermediate member (60; 160) includes, on an external cylindrical surface (62; 162) of the body (61; 161), an external thread (65; 165) complementary to the internal thread (25), and wherein the ring (171) at least partially covers the external thread (165) of the intermediate member (160) in the position for releasing the balls (184).

12. The coupling device (10; 110) according to claim 1, wherein at least one bearing portion among the bearing portion (9) of the coupling element (2; 102) and the bearing portion (39) of the end piece body (30) is a frustoconical surface.

13. The coupling device (10; 110) according to claim 1, wherein it is configured as a female element suitable for receiving a male coupling element (2; 102), with the bearing portion (39) of the end piece body (30) receiving in sealing contact a bearing portion (9) of the male coupling element (2; 102).

14. A connector (R10; R110), adapted to transfer pressurized fluids, wherein it includes:
a coupling device (10; 110) according to claim 1, connected to the first pipe,
as well as a coupling element (2; 102) which is coupled with the coupling device (10; 110) and connected to the second pipe.

15. The connector (R10; R110) according to claim 14, wherein, while the bearing portion (39) of the end piece body (30) is touching a bearing portion (9) belonging to the coupling element (2; 102), the displacement of the end piece body (30) with respect to the coupling element (2; 102) in the forward direction (D1) via the displacement means (40) is capable of establishing the sealing contact between the bearing portion (39) of the end piece body (30) and the bearing portion (9) belonging to the coupling element (2; 102) for sealingly coupling the first and second pipes.

16. The connector (R10; R110) according to claim 15, wherein the sealing contact between the bearing portion (39) of the end piece body (30) and the bearing portion (9) of the male coupling element (2; 102) is made by direct contact of the two surfaces forming the bearing portions (9; 39).

17. The connector according to claim 15, wherein one of both surfaces forming the bearing portions (9; 39) receives a gasket, and wherein the sealing contact between the bearing portion (39) of the end piece body (30) and the bearing portion (9) of the male coupling element (2; 102) is made via the gasket.
